(19) United States
(12) Patent Application Publication
(10) Pub. No.: US 2025/0322674 A1
(43) Pub. Date: Oct. 16, 2025

(54) Driver Behavioral Analysis System Based on Target and Keypoint Detection

(71) Applicant: Transit Pro Tech. Limited, Wan Chai (HK)

(72) Inventors: Weihong Du, Shenzhen (CN); Limin Jiang, Shenzhen (CN)

(73) Assignee: Transit Pro Tech. Limited, Wan Chai (HK)

(21) Appl. No.: 19/094,030

(22) Filed: Mar. 28, 2025

Related U.S. Application Data
(60) Provisional application No. 63/632,425, filed on Apr. 10, 2024.

(51) Int. Cl. G06V 20/59; G06V 10/62; G06V 10/764; G06V 10/77; G06V 10/776; G06V 10/80; G06V 10/82; G06V 40/16; G06V 40/18

(52) U.S. Cl. CPC G06V 20/597; G06V 10/62; G06V 10/764; G06V 10/7715; G06V 10/776; G06V 10/803; G06V 10/806; G06V 10/82; G06V 40/171; G06V 40/176; G06V 40/18

(57) ABSTRACT

A computerized train driver behavioral analysis system for the automated analysis of behavioral characteristics of drivers of railway trains based on target and keypoint detection. A train operation status and position analysis portion monitors train position, speed, and acceleration. A standardized driver practice analysis portion compares actual driver behaviors and actions to standardized driver behaviors and actions. A driver mental state analysis portion automatically detects a driver's face with a human face detection model with automated target keypoint detection to detect predetermined keypoints to produce an electronic human face box and performs a computer analysis of eye and mouth statuses and makes an automated electronic determination whether the eyes and mouth are open or closed. The system thus produces a computerized judgment regarding behavioral characteristics of drivers based on the train operation status and position analysis, standardized driver practice analysis, and driver mental state analysis portions.

### RELATED APPLICATION

This application claims priority to U.S. Provisional Application No. 63/632,425, filed Apr. 10, 2024, which is incorporated herein by reference.

### FIELD OF THE INVENTION

The present invention relates generally to railway systems. More particularly, disclosed herein is a computerized system for the automated analysis of the behavioral characteristics of train drivers, such as drivers of subway trains, based on target and keypoint detection to identify driver fatigue and inattentiveness and, thereby, to improve efficiency and safety awareness and to reduce risks to passengers, drivers, and property.

### BACKGROUND OF THE INVENTION

Train systems provide fast, convenient, safe, and environmentally-friendly public transportation in modern cities. While trains are highly advantageous to riders and to the community, trains often form an enclosed and monotonous work environment for drivers of subway and other trains. Particularly after driving continuously for extended time periods, drivers are prone to becoming distracted and fatigued, which can lead to irregular and dangerous driving behaviors. Severe cases of fatigue and inattentiveness can lead to accidents with potential injuries to passengers and drivers and damage to the train itself.

Attempting to mitigate such risks, operators of train systems issue driving behavior standards and conduct periodic driver assessments. Further, monitoring cameras are often installed in train cockpits to gather video information regarding drivers. Driver videos are typically stored in computer systems, such as those in a dispatch facility, and specialized assessment personnel are tasked with watching the videos to evaluate the drivers. Disadvantageously, this process is time-consuming and exhaustive. Furthermore, the resulting assessments are inherently subjective and are thus prone to error.

In view of the risks to persons and property presented by fatigued and inattentive drivers, there is a real need for a system for automatically monitoring and analyzing the behavioral characteristics of train drivers.

### SUMMARY OF THE INVENTION

Recognizing the risks presented from driver fatigue and inattentiveness, the present invention is founded on the basic object of effectively detecting and identifying driver fatigue and inattentiveness thereby reducing risks to persons and property.

A more particular object of the invention is to provide a system for effectively identifying driver fatigue and inattentiveness based on an automated analysis of behavioral characteristics of train drivers.

A further object of the invention is to provide a system for the analysis of the behavioral characteristics of train drivers that not only ensures safety but also improves efficiency and driver safety-awareness.

In carrying forth the foregoing and further objects and to promote passenger safety and to improve driving efficiency and safety-awareness, the system of the present invention introduces a computerized driver behavioral recognition technique that is based on target and keypoint detection. Through monitoring driver behaviors, such as facial expressions, head positions, arm gestures, and eye fixation, practices of the system disclosed herein discover and facilitate the timely detection and correction of potentially risky driver behaviors, and, in so doing, promote safety-awareness, efficiency, and quality of work. The system of the present invention is further capable of monitoring and analyzing driver work status and providing solid, objective reference data for driver management. As a consequence, the system effectively cuts time and labor costs while increasing the accuracy and objectiveness of driver assessments.

One non-limiting embodiment of the invention can be characterized as a computerized train driver behavioral analysis system for the automated analysis of behavioral characteristics of drivers of railway trains based on target and keypoint detection. The behavioral analysis system includes a computerized train operation status and position analysis portion that is operative to monitor at least one of position, speed, and acceleration of the train electronically thereby producing train status and position information. The system further includes a computerized standardized driver practice analysis portion. Under that portion, standardized driver behaviors and actions that should be adopted by drivers during proper performance are stored in electronic memory, and those standardized driver behaviors and actions are compared in an automated manner by computer to observed actual driver behaviors and actions to determine whether the driver is behaving and acting according to the standardized driver behaviors and actions. The system further includes a computerized driver mental state analysis portion. That portion is operative to determine automatically by computer based on the train status and position information whether the train is in a mobile operating status or in a stopped status. The mental state analysis portion is further operative to detect a human face of a human head of the driver using a computerized human face detection model with automated target keypoint detection operative to detect predetermined keypoints of the human face to produce an electronic human face box, and the mental state analysis portion performs a computer analysis of the statuses of eyes and mouth of the driver based on the human face box and makes an automated electronic determination based on the automated target keypoint detection regarding whether at least one of the eyes and the mouth of the driver are considered to be open or closed. Also according to embodiments of the computerized behavioral analysis system, the human face detection model is further operative to compute a deflection angle of the human head.

Embodiments of the system further comprise one or more cameras that are operative to obtain infrared and visible images of the driver. Actual driver behaviors and actions are determined based on the infrared and visible light images of the driver, and those infrared and visible images of the driver are fused by a multi-level encoder-decoder network.

In practices of the computerized behavioral analysis system, the human face detection model is operative based on a real-time machine-learning object detection algorithm. Where one or more cameras are operative to obtain images of the driver, the human face detection model can operate to label the images of the driver. With data set partitioning, images of the driver are partitioned into a training set, a validation set, and a test set to produce a data set. That data set is used by the system to train and test the human face detection model, such as by use of a gradient descent algorithm.

The detection of predetermined keypoints of the human face can, for instance, be performed with a lightweight human face keypoint detection computer model. The system can retain in electronic memory a threshold value Tₑ for judging if the eyes of the driver are open or closed, and the system can be operative to establish a parameter Lₑ based on detected predetermined keypoints of the human face indicative of open and closed conditions of the eyes. If Lₑ>Tₑ, then the system automatically considers the eyes to be open, and the system otherwise automatically considers the eyes to be closed.

In a similar manner, the system can retain in electronic memory a threshold value Tₘ for judging if the mouth of the driver is open or closed, and the system can be operative to establish a parameter Lₘ based on detected predetermined keypoints of the human face indicative of open and closed conditions of the mouth. If Lₘ>Tₘ, then the system automatically considers the mouth to be open, and the system otherwise automatically considers the mouth to be closed.

Also as taught herein, the standardized driver behaviors and actions can include plural predetermined driver statuses for comparison in an automated manner by computer to observed actual driver behaviors and actions determined based, for instance, on the detection of the predetermined keypoints of the human face. For example, there can be the following predetermined driver statuses: normal driving, eyes closed in excess of a predetermined length of time, yawning, head down or tilted for in excess of a predetermined length of time, telephone usage, and smoking. The system is operative to produce an automated alert when one or more of the actual driver behaviors and actions detected by the computerized system does not correspond with one or more standardized driver behaviors and actions.

The computerized behavioral analysis system can establish a standardized practice framework based on gesture recognition, pose estimation, and action rating of drivers based on images of the drivers. Gesture recognition and pose estimation can be employed in combination to rate actual driver actions based on a level of correspondence and compliance of those actual driver behaviors and actions with predetermined standardized driver behaviors and actions. Gesture recognition can be carried out through an automated, computerized determination of whether a driver is making a standardized gesture, such as by a deep convolutional neural network computer learning and a real-time machine-learning object detection computer algorithm. In a similar manner, pose estimation can be carried forth through an automated, computerized determination of a pose of a driver by use of a computerized pose estimation model with a feature extraction convolutional neural network and a central point detection convolutional neural network.

One will appreciate that the foregoing discussion broadly outlines certain goals and features of non-limiting embodiments of the invention to enable a better understanding of the detailed description that follows and to instill a better appreciation of the inventors' contribution to the art. Before any particular embodiment or aspect thereof is explained in detail, it must be made clear that the following details of construction and illustrations of inventive concepts are mere examples of the many possible manifestations of the invention.

### BRIEF DESCRIPTION OF THE DRAWINGS

Other characteristics and advantages of the invention will become apparent on reading the detailed description that follows with further reference to the accompanying drawings wherein like numbers are used to indicate like components and wherein:

FIG. 1 is a schematic of the general framework of a driver behavior analysis system and technique according to the present invention;

FIG. 2 is a schematic of a driver mental analysis system pursuant to the present invention;

FIG. 3 is a schematic of a multi-level encoder-decoder network as disclosed herein;

FIG. 4 depicts the keypoints of the human face as recorded and analyzed herein;

FIG. 5 is a schematic of the analysis of the standardized practices of the driver in accordance with the present invention; and

FIG. 6 depicts the human skeletal keypoints of a pose estimation model employed pursuant to the present invention.

### DETAILED DESCRIPTION OF PREFERRED EMBODIMENTS

The driver behavioral analysis system and method disclosed herein are subject to numerous embodiments, each within the scope of the invention. However, to ensure that one skilled in the art will be able to understand and, in appropriate cases, practice the present invention, certain preferred embodiments of the system and method are described below with reference to the accompanying drawing figures.

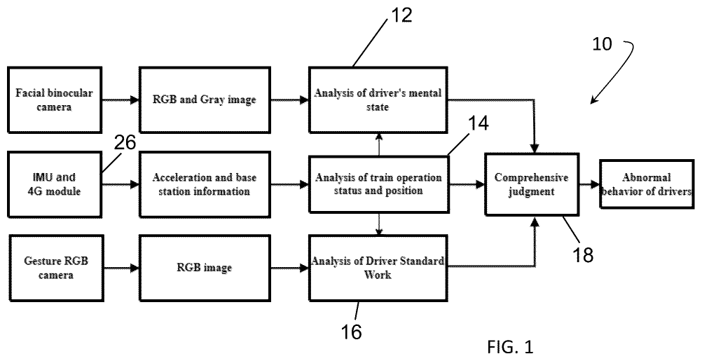

The general framework of the driver behavior analysis system and method of the present invention can be understood with reference to FIG. 1 where the system is indicated generally at 10. As shown, the system 10 is founded on a computerized analysis of the driver's mental state 12 in combination with a computerized analysis of the operation status and real-time position of the train 14 and a computerized analysis of standardized driver practice 16 to produce what can be referred to as a comprehensive, computerized judgment 18 as to the normal or abnormal behavior of the driver.

Herein, it will be observed that referenced components and steps are typically computerized unless a manual aspect is referenced, and computerization, such as through computer processing on a computer processor, electronic data retained in electronic memory, and otherwise. Computerization through computer software and hardware as would be known to a person of ordinary skill in the art after reviewing the present disclosure should be assumed except where the context or express language of the present disclosure dictates otherwise. Where appropriate, depictions of components of the system 10 and illustrated connections and interrelationships between components of the system 10 that would of necessity or advantageously for their function include one or more computer processors, electronic memory, wired or wireless connectivity devices or mechanisms, or other equipment that would be readily known to one of ordinary skill in the art are intended to illustrate those items schematically. For instance, the illustrations of the computerized driver mental state aspect 12, the computerized analysis of the operation and real-time position of the train aspect 14, the computerized analysis of standardized driver practice aspect 16, and the comprehensive, computerized judgment aspect 18 of the system 10 should each be interpreted to include the depiction of the computer processing, memory, and connectivity components necessary to their operation.

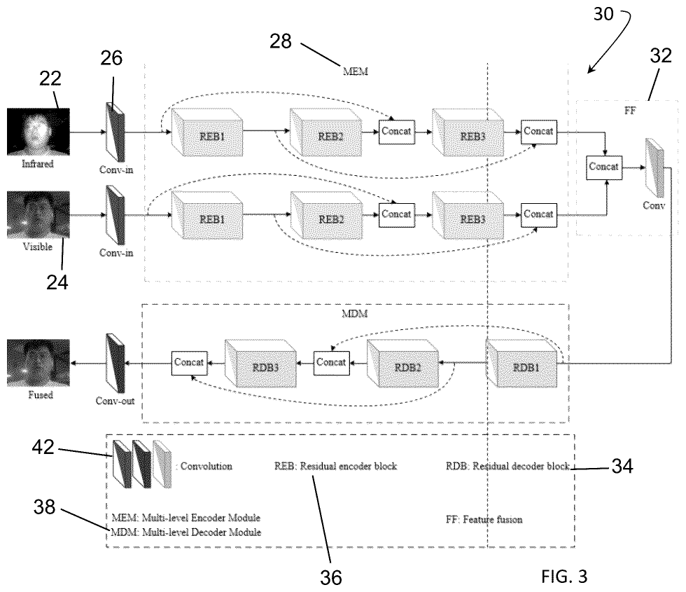

In the driver mental state analysis aspect 12, a dual camera is used to monitor the mental state of the driver and to observe facial traits, such as the degree of fatigue in the eyes, a hanging of the head, indications of distraction, yawning, making phone calls, smoking, and other indications of fatigue and inattentiveness. Individually and in combination, observed facial traits enable a determination of the driver's degree of concentration and his or her ability to react as necessary for safe and efficient operation of the train. In certain non-limiting embodiments, as is illustrated in FIG. 3, the dual cameras comprise an infrared camera 22 and a visible image camera 24. The infrared and visible image cameras 22 and 24 can have the same viewing angle.

In the train operation status and position analysis portion 14 of the system 10, inertia measurement unit (IMU) and 4G communication modules 26 are operative to monitor the position, speed, and acceleration of the train as is depicted in FIG. 1. With the help of the route map, the status and change in status, such as speed, acceleration, deceleration, turning, stopped condition, and potentially other status characteristics, and environmental information, such as nearby turnouts, signalers, and other environmental information relevant to the particular train, its location and movement can be determined by computer.

In the standardized driver practice analysis portion 16 of the system 10, standardized driver behaviors and actions that should be adopted by the drivers during proper performance are determined. These may be determined, for instance, based on computer algorithms, standard operating procedures recorded in computer memory, or some combination thereof. These standardized behaviors and actions are then compared to observed actual behaviors and actions of the driver to determine if the driver is acting according to standard operating procedures and standardized driver behaviors and actions. During operation, electronic sensors and computer algorithms monitor, analyze, and recognize driver behaviors and actions in real time. The results are sent to the management system 10 so that the system 10 can assess and remind the driver in real time, such as but not limited to through one or more of an audible of visible alarm, a textual message, a telephone call, or any other reminder indication. Driver efficiency and safety-awareness with respect to expected and standardized behaviors and actions are thus improved.

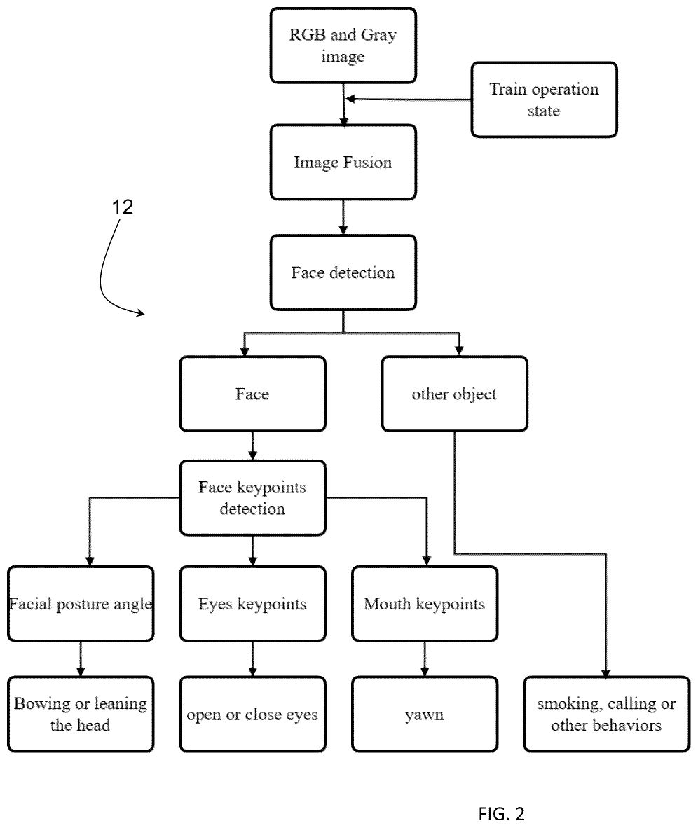

A further understanding of the computerized analysis of the mental state of the driver can be obtained with reference to FIG. 2 where the framework of the driver mental state analysis system is again indicated generally at 12. In one practice, the framework of the driver mental state analysis system 12 includes the elements or steps referenced below as Driver Elements A through E.

In Driver Element A, a determination is made using the train status and position information 14 as in FIG. 1 to determine whether the train is in a mobile operating status or in a temporary stopped status. The human face of the driver is electronically detected in Driver Element B using computerized target detection, and an electronic human face box is extracted for analysis. Driver Element C comprises obtaining computerized analysis results with respect to the status of the eyes and mouth of the driver after the completion of human face detection. Under Driver Element D, further analysis of the status of eyes and mouth is carried out using 98 keypoints. Based on the results from target and keypoint detection, Driver Element E is carried out wherein the open and closed positions of the eyes and mouth and the deflection angle of the driver's head are determined through a computerized analysis of single frames.

According to practices of the invention, infrared imaging with one or more infrared cameras 22 producing infrared images as in FIG. 3 has the advantage of being able to capture images in the dark and through certain obstructions, such as sunglasses. However, infrared images are usually dark and lacking in color, low in signal-to-noise ratio, and prone to interference from reflected light, such as from lenses. RGB images obtained by one or more visible image cameras 24, such as visible image RGB cameras 24 producing RGB images, on the other hand, are high in contrast and contain more detailed information about the objects, but RGB images are usually of low quality when taken in dim light. As contemplated herein, infrared images can be exploited as main images and enhanced using RGB images. With that, the advantages of the infrared image are preserved while its contrast and signal-to-noise ratio are improved. Image features under reflected light are also boosted.

Embodiments of the system 10 introduce a computerized multi-level encoder-decoder network called the Fused Decoder-Encoder network (FDEnet), which can be used to fuse infrared and visible light images. The general framework on an FDEnet is indicated generally at 30 in FIG. 3. The FDEnet 30 includes three main computerized steps: feature encoding, feature fusion, and feature decoding. The working principle of the FDEnet 30 in achieving the fusion of infrared and visible light images is described below.

Feature encoding: First, the infrared and visible light images from infrared and visible light cameras 22 and 24 are sent into an input convolutional layer 26, which may have, for instance, 16 3×3 filters to obtain an initial feature map. Then, the initial feature map is sent into a multi-level encoder module (MEM) 28. The MEM 28 includes two independent multi-level branches, each containing three residual encoding blocks (REB) and connection layers. Every residual encoding block consists of two convolutional layers with filter sizes 3×3, a batch normalization layer, an activation layer, and an adder. The adder is operative only to add the values in the matrices of the feature maps, causing no changes to the feature dimensions. The two encoding branches generate two feature maps, of sizes such as 360×640×16, respectively. Residual encoding blocks and batch normalization will be understood by one of ordinary skill in the present art. However, it is observed that He K., Zhang X., Ren S., et al. Deep Residual Learning for Image Recognition [J]. IEEE, 2016.DOI:10.1109/CVPR.2016.90, which is incorporated by reference, provides a discussion of such residual encoding blocks, and batch normalization is discussed in S. Ioffe and C. Szegedy. Batch normalization: Accelerating deep network training by reducing internal covariate shift. In ICML, 2015, which is also incorporated herein by reference.

Feature fusion: The feature fusion module 32 consists of a connection layer and a convolutional layer. Computerized feature maps are sent into the feature fusion module 32 in a connection process step. In this non-limiting example, a feature map of size 360×640×32 is generated. After dimensional transformation using a convolutional layer, such as one with a filter size of 5×5, an encoded feature map of size 360×640×16 is obtained.

Feature decoding: Referring again to the general framework of the FDEnet 30 of FIG. 3, the decoding process uses a similar branch structure to that of the encoder 36 to compensate for the information loss in the decoding process and thereby to improve the information exchange between different layers. That is, the residual decoding block (RDB) 34 is similar to the residual encoding blocks (REB) 36. The fused feature maps are sent into the multi-level decoding module (MDM) 38 for feature decoding to obtain feature maps, which in one non-limiting example are of size 360×640×16. These feature maps from the MDM 38 are then sent to the output convolutional layer 42 with, for instance, 16 3×3 filters, to generate the fusion images.

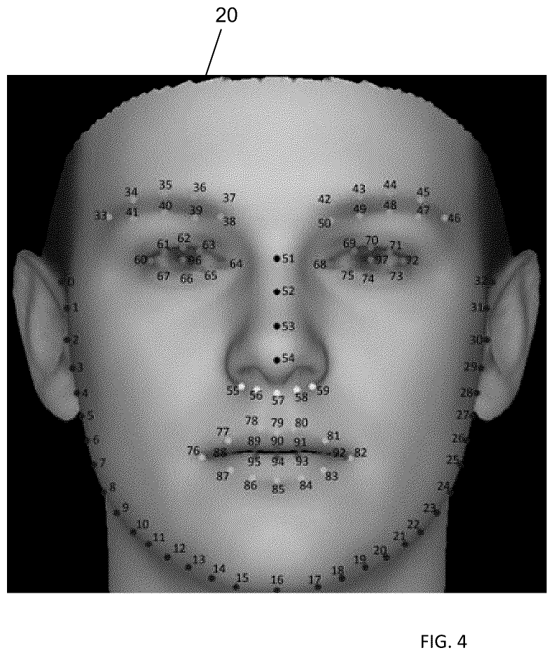

In Driver Element B, the human face of the driver is electronically detected using target detection, and an electronic human face box 20 is extracted for analysis as is illustrated in FIG. 4. The detection of the human face includes a detection of the open or closed condition of the eyes and mouth to be analyzed. For confirmation and analysis, these detection results are compared with keypoint detection results by computer in a later stage as further described herein. To remove interference, targets that may affect keypoint detection, such as masks, eyeglasses, hats, and other interfering targets, can also be checked.

As its backbone, the human face detection model uses a real-time machine-learning object detection computer algorithm, such as that created and distributed under the trademark YOLOv5™ (You Only Look Once, Version 5™) by Ultralytics Inc. of Frederick, Maryland. The YOLO™ series of machine-learning algorithms detect objects using features learned by a deep convolutional neural computer network. In practices of the system 10, the size of the input images is 512×512. A person of ordinary skill in the present art will understand such machine-learning algorithms, and further discussion of the YOLO™ machine-learning algorithm can be found in Fu J., Zheng H., Mei T. Look Closer to See Better: Recurrent Attention Convolutional Neural Network for Fine-Grained Image Recognition [C]//IEEE Conference on Computer Vision & Pattern Recognition. IEEE, 2017.DOI:10.1109/CVPR.2017.476, which is incorporated herein by reference.

In the first step of constructing the human face detection model, a data set of original electronic data is prepared. The data set in one non-limiting embodiment contains more than 20,000 images captured in a simulated subway train cockpit for 30 drivers. In the second step, labeling of the images, which can be done manually, is performed. Targets are searched for in multiple categories, seven in one non-limiting example comprising human body, face, eyes, mouth, mask, eyeglasses, and hat. The images are collected and labeled using data labeling software, and label files that have a one-to-one correspondence with the image names are generated. In the third step, data set partitioning is performed. There, the data set is partitioned into a training set, a validation set, and a test set. This can, for instance, be done in an 8:1:1 ratio. In the fourth step, the data set is used to train and test the computer model.

The training process for the computer model can use a gradient descent computer algorithm that is operative as an optimization algorithm. Such algorithms can, for instance, follow the negative gradient of an objective function to locate the minimum of the function. In certain embodiments, the gradient descent algorithm can be the one that is distributed under the name Adam (Adaptive Moment Estimation) optimizer. One of ordinary skill in the art will understand such gradient descent algorithms. By way of further background, it is noted that the Adam gradient descent algorithm was presented by Diederik Kingma from OpenAI™, Inc. of San Francisco, California and Jimmy Ba from the University of Toronto in their 2015 ICLR paper titled “Adam: A Method for Stochastic Optimization,” which is incorporated herein by reference. The gradient descent algorithm can, for example, employ a batch size of 16 in the training process.

In Driver Element C, computerized analysis results are obtained regarding the status of the eyes and mouth of the driver after the completion of human face detection. To improve the accuracy of the detection, a computerized detection of predetermined keypoints is used to check the status of the eyes and mouth. Predetermined keypoints on human faces are also used to compute the deflection angle of the head, which enables a determination of, for instance, whether the driver has turned his or her head to the side or whether the driver has hung his or her head low.

FIG. 4 shows 98 individually-numbered keypoints of the human face that are employed in embodiments of the human face box 20 of the system 10. There, the keypoints trace the eyes, eyebrows, nose, mouth, and jaw line of the human face. Thus, according to the practices of the system 10, the computer data used for keypoint detection are human face boxes 20 selected by a human face detection model. Keypoints of the human face, which again comprise 98 points in this non-limiting embodiment, are manually labeled, and the keypoint human face detection model is trained and tested.

The model used for keypoint detection can, for instance, be a lightweight computerized human face keypoint detection model, such as the Practical Facial Landmark Detector (PFLD) computer model. Progressive training is used to improve performance of the detection model gradually. The PFLD model has the characteristics of lightweight design, multitask learning, and data enhancement. It can detect keypoints on a human face quickly and accurately. One of ordinary skill in the present art would be aware of such detection models. Further background can be had by reference, for example, to Guo, Xiaojie, et al. “PFLD: A Practical Facial Landmark Detector.” (2019), which is incorporated herein by reference and which provides further discussion of the PFLD model.

After the completion of the human face model, an output of the human face box 20 from the target detection stage is sent into the keypoint detection model. The keypoint detection model generates output data of the positions of the 98 keypoints on the human face as well as the deflection angle of the head in three directions, namely, the pitch angle, yaw angle, and roll angle.

Further analysis of the status of eyes and mouth using the 98 keypoints on the human face can be carried out according to the Driver Element D of the system 10. The parameter Lₑ is introduced to analyze the open and closed conditions of the eyes. The larger the value of Lₑ, the wider the eyes are open. A threshold value Tₑ is defined for judging whether the eyes are open or closed. If Lₑ>Tₑ, then the eyes are considered open. Otherwise, the eyes are considered closed. The value of Lₑ is calculated as:

$${L}_{e} = \frac{\sum {L}_{eu} - \sum {L}_{ed}}{H} ,$$

where Lₑᵤ represents the ordinates of the keypoints on the upper eyelid, that is, the ordinates of the six points marked as 61, 62, 63, 69, 70, 71. L_{ed} represents the ordinates of the keypoints on the lower eyelid, that is, the ordinates of the six points marked as 65, 66, 67, 73, 74, 75. H in the denominator is the height of the face box. To prevent errors caused by the back-and-forth motion from the driver, the height of the face box is used as a reference.

The parameter Lₘ is used to analyze the open and close positions of the mouth. The larger the value of Lₘ, the wider the mouth is open. A threshold value Tₘ is defined for judging if the mouth is open or closed. If Lₘ>Tₘ, then the mouth is presumed to be open, otherwise, it is presumed to be closed. The value of Lₘ is calculated as:

$${L}_{m} = \frac{\sum {L}_{mu} - \sum {L}_{md}}{H} ,$$

where Lₘᵤ represents the ordinates of the keypoints on the upper lip, that is, the five keypoints marked as 77, 78, 79, 80, 81, and L_{md} represents the ordinates of the keypoints on the lower lip, that is, the five keypoints marked as 83, 84, 85, 86, 87.

In Driver Element E, based on the results from target and keypoint detection, the open and closed positions of the eyes and mouth and the deflection angle of the driver's head can be determined through the analysis of single frames. The status of the driver can be determined by analyzing the continuous video. There can be, for instance, six driver statuses: normal driving, eyes closed for an excessive amount of time, yawning, head down or tilted for an excessive amount of time, telephone usage, and smoking.

For the eyes-closed-for-an-excessive-amount-of-time status, the percentage of open or closed eyes over a given predetermined time period, such as 3 seconds in one practice, is calculated. When the eyes are closed more than a predetermined percentage of the given time period, such as more than 80%, driver fatigue is presumed. A second-degree driver fatigue alert is issued. If the driver fatigue lasts for three consecutive time units, a first-degree driver fatigue alert is issued.

For the yawning status, if the mouth of the driver is open for longer than a predetermined time period, such as 2.5 seconds or more, yawning is presumed. Where yawning is presumed, a second-degree driver fatigue alert is issued.

For the head-down-or-tilted-for-an-excessive-amount-of-time status, if the absolute value of the pitch angle, which can for example range from −60° to 70°, is greater than a predetermined angle, such as 45°, the driver's head is judged to be down. If the absolute value of the yaw angle, which can for example range from −75° to 75°, is greater than a predetermined angle, such as 30°, the driver's head is judged to be tilted. When the driver's head is judged based on the foregoing computer analysis to be down or tilted for in excess of a predetermined period of time continuously, such as 5 seconds or more continuously, lack of concentration in the driver is presumed, and a lack-of-concentration alert is issued.

For the making-a-phone-call status, if the driver is on a phone call for longer than a predetermined length of time, such as 3 seconds or more, continuously, telephone usage is presumed and confirmed, and a second-degree driver fatigue alert is issued.

For the smoking status, if the driver smokes for longer than a predetermined length of time, such as 2 seconds or more, continuously, smoking is presumed and confirmed, and a second-degree driver fatigue alert is issued.

Pursuant to the embodiments of the system 10, the analysis of train operational status and position includes what may be referred to as Train Elements A and B. In Train Element A, real-time acceleration data, including gravitational acceleration, of the train is collected by an inertia measurement unit (IMU). To estimate the speed of the train accurately, gravitational acceleration is removed. Because of this, accelerations on the x and y axis as collected by the IMU, aₓ and a_{y}, are used to analyze operational status, including the change in speed and direction, of the train. The direction is determined using aₓ. When aₓ>0, the train is moving forward. When aₓ<0, the train is moving backward. The speed of the train is calculated from the acceleration data using the equation:

$$v = {v}_{0} + \sqrt[2]{{a}_{x}^{2} + {a}_{y}^{2}} Δ t ,$$

where v₀ is the initial speed of the train and Δt is the time interval between data acquisition.

Under Train Element B, the position of the train is determined. In one practice, an electromagnetic wave is transmitted from the train, and the time, t, for the electromagnetic wave to reach one or more adjacent base stations is obtained and stored in electronic memory, such as a SIM card or other electronic memory. With the latitude and longitude, denoted as (x, y), of regional base stations and the time, t, for the electromagnetic wave to reach these base stations known, the approximate position of the train can be calculated based on the coordinates of one or more base stations given that the positional information of the base stations is known. If only one base station can be found based on electronic data stored in the SIM card or other electronic memory, potentially because of the uncertainty on the obstacles in the line, the train may be assumed to be at this base station. If multiple base stations are detected based on the electronic data stored in the SIM card or other electronic memory, triangulation, such as with the least squares method, can be used to obtain the current position of the train. According to embodiments of the invention, the triangulation of the train's position can be found as follows:

$$X = {( {A}^{T} A )}^{- 1} {A}^{T} B ,$$

$$where$$

$$A = [ \begin{matrix}2 ( {x}_{1} - {x}_{n} ) & 2 ( {y}_{1} - {y}_{n} ) \\ ⋮ & ⋮ \\ 2 ( {x}_{n - 1} - {x}_{n} ) & 2 ( {y}_{n - 1} - {y}_{n} )\end{matrix} ] , B = [ \begin{matrix}{x}_{1}^{2} - {x}_{n}^{2} + {y}_{1}^{2} - {y}_{n}^{2} + {d}_{1}^{2} - {d}_{n}^{2} \\ ⋮ \\ {x}_{n - 1}^{2} - {x}_{n}^{2} + {y}_{n - 1}^{2} - {y}_{n}^{2} + {d}_{n - 1}^{2} - {d}_{n}^{2}\end{matrix} ] ,$$

and
n is the number of base stations found, di=555×tᵢ is the distance between the i^{th} base station and the train, and X is the coordinate vector of the train's position.

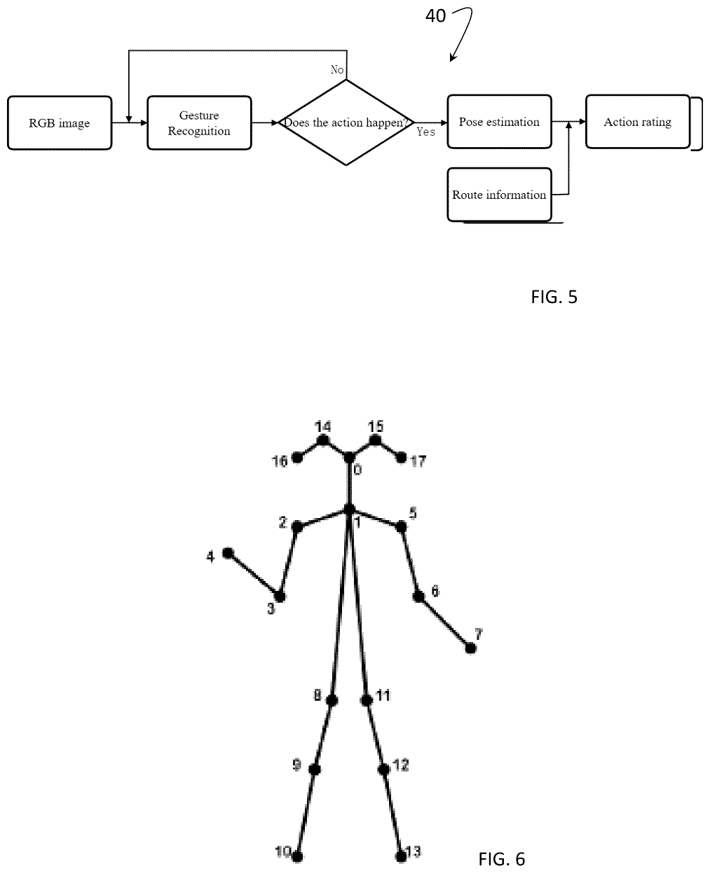

The general framework for the analysis of the standardized practices of the driver can be further understood with reference to FIG. 5 where that framework is indicated generally at 40. The standardized practice framework 40 can be carried forth with three parts based on one or more obtained images, such as RBG images. The three parts of the framework 40 comprise gesture recognition, pose estimation, and action rating. In the gesture recognition part, the driver is checked for whether or not he or she is making a standardized gesture. In the pose estimation part, an estimation of the pose for the entire action clip is carried out. In the third part, a rating is given on the correspondence of the driver's action as according to the standardized gesture.

In the first part of the standardized practice framework 40, gesture recognition, standardized gestures made by the drivers are detected using an end-to-end intelligent target detection method. Utilizing deep convolutional neural network computer learning, this method automatically fits the target position and identifies the target type based on the features of the extracted images to improve accuracy. The gesture recognition model uses a real-time machine-learning object detection computer algorithm, such as that created and distributed under the trademark YOLOv5™ (You Only Look Once, Version 5™) by Ultralytics Inc. of Frederick, Maryland. The YOLO™ series of machine-learning algorithms detect objects using features learned by a deep convolutional neural computer network. In one non-limiting practice of the system 10, input images have a size of 640×640.

The gesture recognition model is constructed in three steps. In Step 1, original data is prepared. The data set for the original data contains image frames from a simulated train cockpit. For instance, the data set for the original data can be established from video, such as more than 50 hours of video, captured in a simulated subway train cockpit for 30 drivers. In Step 2, image frames are labeled, which can be done manually. For instance, plural target gestures, such as of nine different types, in the image frames of the video are found, collected, and labeled using data labeling software. Label files with one-to-one correspondence with the image names are generated. The plural predetermined gesture types in one example of the system are left-hand sword finger, right-hand sword finger, fist, palm upward, palm downward, button pushing, making a phone call, mask removal, and face touching. Step 3 comprises data set partitioning. There, the data set is partitioned into a training set, a validation set, and a test set. These can be apportioned in an 8:1:1 ratio. The data set so produced is used to train and test the computer model, such as through a gradient descent algorithm. In certain embodiments, the gradient descent algorithm can be the one distributed under the name Adam as referenced previously herein. A batch size of, for instance, 16 can be used in the training process.

In the pose estimation part of the framework 30 of the analysis of the standardized practices of the driver, core purposes including predicting the motion of human skeletal keypoints, recognizing candidate actions after gesture recognition, and making inference based on gestures recognized through gesture recognition. In the non-limiting example of FIG. 6, 18 human skeletal keypoints are shown.

An object pose estimation computer model is used for detecting human skeletal keypoints. In embodiments of the system 10, the object pose estimation model is that published under the CenterPose™ trademark by researchers from Shanghai Jiao Tong University and Tongji University, both in Shanghai, China. The object pose estimation model construction procedure is similar to that of the gesture recognition model previously described, except that the source of data is different. In one practice, the object pose estimation model uses the data set referred to as the Common Objects in Context (COCO) data set developed by the Microsoft Research Team, a research subsidiary of Microsoft® Corporation of Redmond, Washington. An automatic labeling tool, such as that published as the OpenPose™ model, a pose estimation system developed by researchers at Carnegie Mellon University (CMU), is trained to label part of the image data automatically during gesture recognition and to generate label files. One of ordinary skill in the present art would be aware of each of the foregoing models. For further background, a discussion of the CenterPose™ object pose estimation model can be found in Zhou X., Wang D., Krhenbühl, Philipp. Objects as Points [J]. 2019.DOI:10.48550/arXiv.1904.07850, which is incorporated herein by reference. A discussion of the OpenPose™ model may be found in Cao Z., Simon T., Wei S E. et al. Realtime Multi-person 2D Pose Estimation Using Part Affinity Fields [C]//2017 IEEE Conference on Computer Vision and Pattern Recognition (CVPR). IEEE, 2017. DOI:10.1109/CVPR.2017.143, which is also incorporated herein by reference.

The CenterPose™ object pose estimation model consists of two main modules: a feature extraction network and a central point detection network. The feature extraction network can be a pre-trained convolutional neural network, such as that published under the trademark ResNet50™, which was developed by the Microsoft Research Team, a research subsidiary of Microsoft® Corporation of Redmond, Washington. Relevant discussion can be found in He, Kaiming; Zhang, Xiangyu; Ren, Shaoqing; Sun, Jian (10 Dec. 2015). Deep Residual Learning for Image Recognition. arXiv:1512.03385, which is incorporated herein by reference.

The central point detection model is a multi-stage convolutional neural network used to detect the centers of the skeletal keypoints from feature images. A loss function uses a weighted sum of Heatmap loss and Part Affinity Fields (PAF) loss. Heatmap loss is used to calculate errors in the predicted center of the keypoints, and the PAF loss is used to calculate error in the predicted vector field between the keypoints. During computer training, optimization algorithms, such as batch SGD (Stochastic Gradient Descent), may be used to minimize the loss function.

In the meantime, to enhance detection under the dim light typical of railway tunnels, a great amount of image data taken in dim light is used to improve robustness and the ability to generalize the model. After training is completed, the percentage of correct keypoints (PCK), especially those on the arms and shoulders, is used to evaluate the model. Once the model is constructed, every frame of the video is sent into the computer model as an input, and the computer model generates the coordinates of the 18 skeletal keypoints.

In the example of FIG. 6, keypoint 2 is on the right shoulder, keypoint 3 is on the right elbow, keypoint 4 is on the right arm, keypoint 5 is on the left shoulder, keypoint 6 is on the left elbow, and keypoint 7 is on the left arm. These keypoints 2-7 can be used to estimate the direction of the gesture. Specifically, the angle between the upper and lower arm is first calculated. The direction of the gesture is then estimated using the relative positions of the keypoints. In practices of the invention, the formula used to calculate this angle is as follows:

$${d}_{23} = \sqrt{{[ {p}_{2} ( x ) - {p}_{3} ( x ) ]}^{2} + {[ {p}_{2} ( y ) - {p}_{3} ( y ) ]}^{2}}$$

$${d}_{34} = \sqrt{{[ {p}_{3} ( x ) - {p}_{4} ( x ) ]}^{2} + {[ {p}_{3} ( y ) - {p}_{4} ( y ) ]}^{2}}$$

$${d}_{24} = \sqrt{{[ {p}_{2} ( x ) - {p}_{4} ( x ) ]}^{2} + {[ {p}_{2} ( y ) - {p}_{4} ( y ) ]}^{2}}$$

$${θ}_{right} = arccos ( \frac{{d}_{23}^{2} + {d}_{34}^{2} - {d}_{24}^{2}}{2 {d}_{23} {d}_{34}} ) ,$$

where pᵢ (x) and pᵢ (y) are the abscissa and ordinate of keypoint i, respectively, d₂₃ is the distance between keypoint 2 on the right shoulder and keypoint 3 on the right elbow, d₃₄ is the distance between keypoint 3 on the right elbow and keypoint 4 on the right arm, d₂₄ is the distance between keypoint 2 on the right shoulder and keypoint 4 on the right arm, and θ_{right} is the action angle of the right arm. The action angle of the left arm, θ_{left}, can be obtained in a similar fashion.

After storing the action angles calculated as above from continuous image frames in a list, the gradient, denoted as grade, of these angles is computed and is used to estimate the direction of the gesture. Positive grade means the action angle is increasing, and the arm is inferred to be extending. Negative grade means the action angle is decreasing, and the arm is inferred to be retracting. The formula used to calculate the gradient is as follows:

$${grad}_{θ} = \frac{{θ}_{t + 1} - {θ}_{t}}{{θ}_{t}} ,$$

where θₜ is the action angle in the current image frame and θₜ₊₁ is the action angle in the next image frame.

The gesture recognition and pose estimation described above are employed in combination to rate the driver action based on its level of correspondence and compliance with the predetermined standards. There can, for instance, be three rating classes, such as good, pass, and fail. For example, in certain implementations of the system 10, when the gesture recognition result indicates that the driver made a standard left-hand or right-hand sword finger and followed it with candidate actions, the gesture direction estimation results and the existence of a turnout or signaler will be used to conduct the analysis. If the extension and retraction action of the driver's arm is complete and there is, indeed, a turnout or signaler, then the action will be rated as “good”. If only an extension or retraction action is detected and there is a turnout or signaler, the action will be rated as “pass”. All other situations will be rated as “fail”.

With certain details and embodiments of the present invention for a train driver behavioral analysis system 10 based on target and keypoint detection disclosed, it will be appreciated by one skilled in the art that numerous changes and additions could be made thereto without deviating from the spirit or scope of the invention. This is particularly true when one bears in mind that the presently preferred embodiments merely exemplify the broader invention revealed herein. Accordingly, it will be clear that those with major features of the invention in mind could craft embodiments that incorporate those major features while not incorporating all of the features included in the preferred embodiments.

Therefore, the following claims shall define the scope of protection to be afforded to the invention. Those claims shall be deemed to include equivalent constructions insofar as they do not depart from the spirit and scope of the invention. It must be further noted that a plurality of the following claims may express, or be interpreted to express, certain elements as means for performing a specific function, at times without the recital of structure or material. As the law demands, any such claims shall be construed to cover not only the corresponding structure and material expressly described in this specification but also all legally-cognizable equivalents thereof.

The following is claimed as deserving the protection of Letters Patent:

1. A computerized train driver behavioral analysis system for the automated analysis of behavioral characteristics of a driver of a railway train based on target and keypoint detection, the behavioral analysis system comprising:
a computerized train operation status and position analysis portion operative to monitor at least one of position, speed, and acceleration of the train electronically to produce train status and position information;
a computerized standardized driver practice analysis portion wherein standardized driver behaviors and actions that should be adopted by drivers during proper performance are stored in electronic memory and wherein the standardized driver behaviors and actions are compared in an automated manner by computer to observed actual driver behaviors and actions to determine whether the driver is behaving and acting according to the standardized driver behaviors and actions; and
a computerized driver mental state analysis portion wherein the driver mental state analysis portion is operative to determine automatically by computer based on the train status and position information whether the train is in a mobile operating status or in a stopped status, to detect a human face of a human head of the driver using a computerized human face detection model with automated target keypoint detection operative to detect predetermined keypoints of the human face to produce an electronic human face box, to perform a computer analysis of the statuses of eyes and mouth of the driver based on the human face box, and to make an automated electronic determination based on the automated target keypoint detection regarding whether at least one of the eyes and the mouth of the driver are considered to be open or closed;
whereby the behavioral analysis system is operative to produce a computerized judgment regarding behavioral characteristics of drivers of railway trains based on the train operation status and position analysis, standardized driver practice analysis, and driver mental state analysis portions.

2. The computerized behavioral analysis system of claim 1, further comprising one or more cameras operative to obtain infrared and visible images of the driver, wherein the actual driver behaviors and actions are determined based on the infrared and visible light images of the driver, wherein the infrared and visible images of the driver are fused by a multi-level encoder-decoder network.

3. The computerized behavioral analysis system of claim 2, wherein the multi-level encoder-decoder network operates to produce an initial feature map by processing the infrared and visible images of the driver through an input convolutional layer, then to process the initial feature map through a multi-level encoder module and a feature fusion module to produce an encoded, fused feature map, and then to process the encoded, fused feature map through a residual decoding block.

4. The computerized behavioral analysis system of claim 1, wherein the human face detection model is operative based on a real-time machine-learning object detection algorithm.

5. The computerized behavioral analysis system of claim 4, further comprising one or more cameras operative to obtain images of the driver, wherein the human face detection model is further operative to label the images of the driver, and wherein the system performs data set partitioning of the images of the driver into a training set, a validation set, and a test set thereby to produce a data set.

6. The computerized behavioral analysis system of claim 5, wherein the system is operative to use the data set to train and test the human face detection model by use of a gradient descent algorithm.

7. The computerized behavioral analysis system of claim 1, wherein the human face detection model is further operative to compute a deflection angle of the human head.

8. The computerized behavioral analysis system of claim 1, wherein the detection of predetermined keypoints of the human face is performed with a human face keypoint detection computer model.

9. The computerized behavioral analysis system of claim 8, wherein the system retains in electronic memory a threshold value Tₑ for judging if the eyes of the driver are open or closed, wherein the system is operative to establish a parameter Lₑ based on detected predetermined keypoints of the human face indicative of open and closed conditions of the eyes, and wherein, if Lₑ>Tₑ, then the system automatically considers the eyes to be open and wherein system otherwise automatically considers the eyes to be closed.

10. The computerized behavioral analysis system of claim 9, wherein the parameter Lₑ is calculated as:
$${L}_{e} = \frac{\sum {L}_{eu} - \sum {L}_{ed}}{H} ,$$
where Lₑᵤ represents ordinates of predetermined keypoints on the upper eyelid, L_{ed} represents ordinates of predetermined keypoints on the lower eyelid, and H represents a height of the human face box.

11. The computerized behavioral analysis system of claim 8, wherein the system retains in electronic memory a threshold value Tₘ for judging if the mouth of the driver is open or closed, wherein the system is operative to establish a parameter Lₘ based on detected predetermined keypoints of the human face indicative of open and closed conditions of the mouth, and wherein, if Lₘ>Tₘ, then the system automatically considers the mouth to be open and wherein system otherwise automatically considers the mouth to be closed.

12. The computerized behavioral analysis system of claim 11, wherein the parameter Lₘ is calculated as:
$${L}_{m} = \frac{\sum {L}_{mu} - \sum {L}_{md}}{H} ,$$
where Lₘᵤ represents the ordinates of the keypoints on the upper lip and L_{md} represents the ordinates of the keypoints on the lower lip, and H represents a height of the human face box.

13. The computerized behavioral analysis system of claim 8, wherein the standardized driver behaviors and actions include plural predetermined driver statuses for comparison in an automated manner by computer to observed actual driver behaviors and actions determined based on the detection of the predetermined keypoints of the human face.

14. The computerized behavioral analysis system of claim 13, wherein there are at least the following predetermined driver statuses: normal driving, eyes closed in excess of a predetermined length of time, head down or tilted in excess of a predetermined length of time, and telephone usage.

15. The computerized behavioral analysis system of claim 14, wherein the system is operative to produce an alert when one or more of the actual driver behaviors and actions does not correspond with one or more standardized driver behaviors and actions.

16. The computerized behavioral analysis system of claim 1, further comprising a standardized practice framework based on at least one of gesture recognition, pose estimation, and an action rating of drivers based on images of the drivers.

17. The computerized behavioral analysis system of claim 16, wherein gesture recognition and pose estimation are employed in combination to rate actual driver actions based on a level of correspondence and compliance of the actual driver behaviors and actions with predetermined standardized driver behaviors and actions.

18. The computerized behavioral analysis system of claim 16, wherein gesture recognition comprises an automated, computerized determination of whether a driver is making a standardized gesture.

19. The computerized behavioral analysis system of claim 18, wherein gesture recognition is performed by use of deep convolutional neural network computer learning and a real-time machine-learning object detection computer algorithm.

20. The computerized behavioral analysis system of claim 16, wherein pose estimation comprises an automated, computerized determination of a pose of a driver by use of a computerized pose estimation model with a feature extraction convolutional neural network and a central point detection convolutional neural network.
